(19) United States
(12) Patent Application Publication
(10) Pub. No.: US 2021/0332808 A1
(43) Pub. Date: Oct. 28, 2021

(54) FLUID PUMP

(71) Applicant: FANER AROMA PRODUCT CO., LTD., Guangzhou City (CN)

(72) Inventors: HSU-HUI CHANG, New Taipei City (TW); LU-QIANG LIN, Guangzhou City (CN)

(21) Appl. No.: 16/856,064

(22) Filed: Apr. 23, 2020

(51) Int. Cl. F04B 9/14

(52) U.S. Cl. CPC F04B 9/14

(57) ABSTRACT

A fluid pump includes a press head portion, first and second unidirectional-valves, and extensible sleeve-pipe. Disposed in the press head portion, the first unidirectional-valve allows fluid to flow from its second end to its first end. The extensible sleeve-pipe includes a rebound element and outer and inner pipes which form a capacity-variable storage chamber. The inner pipe has a first end communicating with the first unidirectional-valve and a second end fitted to a first end of the outer pipe. The second unidirectional-valve allows the fluid to flow from its second end to its first end. The first end of the second unidirectional-valve communicates with the second end of the outer pipe. Upon contraction displacement of the inner pipe, the fluid flows from the storage chamber into the discharge passage via first unidirectional-valve. Upon expansion displacement of the inner pipe, the fluid flows into the storage chamber via second unidirectional-valve.

### BACKGROUND OF THE INVENTION

### 1. Field of the Invention

The present disclosure relates to pumps, and in particular to a press-style fluid pump

### 2. Description of the Related Art

Fluid pumps are widely used in daily life. People have any type of fluid contained in a container, such as a makeup bottle, as needed. Later, people draw the fluid from the container by pressing a fluid pump mounted on the container.

Conventional fluid pumps are each equipped with a built-in spring for the purpose of restoration. The built-in spring is always in contact with the fluid; as a result, the built-in spring is likely to rust, leading to contamination of the fluid. Furthermore, each instance of pressing a conventional fluid pump does not guarantee constancy of the amount of the fluid thus drawn.

### BRIEF SUMMARY OF THE INVENTION

An objective of the present disclosure is to provide a press-style fluid pump.

To achieve at least the above objective, the present disclosure provides a fluid pump, comprising: a press head portion having a discharge channel and a discharge vent; a first unidirectional valve disposed in the press head portion and adapted to allow a fluid to flow from a second end of the first unidirectional valve to a first end of the first unidirectional valve, wherein the first end of the first unidirectional valve is in communication with the discharge channel; an extensible sleeve pipe comprising an outer pipe, an inner pipe and a rebound element, wherein the inner pipe has a first end being in communication with the first unidirectional valve and a second end fitted to the first end of the outer pipe, wherein the inner pipe and the outer pipe form a capacity-variable storage chamber and connect to the rebound element; and a second unidirectional valve whereby a fluid flows from a second end thereof to a first end thereof, the first end being in communication with the second end of the outer pipe, wherein, upon contraction displacement of the inner pipe, the storage chamber has a greater pressure than the first unidirectional valve, thereby allowing the fluid to exit the storage chamber and enter the discharge passage via the first unidirectional valve, wherein, upon expansion displacement of the inner pipe, a pressure between the outside and the storage chamber is greater than a pressure of the second unidirectional valve, thereby allowing the fluid to flow into the storage chamber via the second unidirectional valve.

In an embodiment of the present disclosure, the first unidirectional valve comprises a first valve unit, a first resilient element, a first ball and a first cork tube, wherein the first resilient element, the first ball and the first cork tube are disposed in the first valve unit, wherein a second end of the first cork tube is in communication with the first end of the inner pipe, wherein the first resilient element presses the first ball, such that the first ball normally abuts against the first end of the first cork tube.

In an embodiment of the present disclosure, the second unidirectional valve comprises a second valve unit, a second resilient element, a second ball and a second cork tube, wherein the second resilient element, the second ball and the second cork tube are disposed in the second valve unit, wherein the second resilient element presses the second ball, such that the second ball is normally fitted inside the second cork tube.

In an embodiment of the present disclosure, the first end of the inner pipe extends outward to form a top portion which an end of the rebound element abuts against.

In an embodiment of the present disclosure, the fluid pump further comprises a gas-admitting member and a unidirectional gas piston, the gas-admitting member having a gas-releasing passage in communication with the gas chamber and the discharge channel, wherein the gas-admitting member surrounds the extensible sleeve pipe, such that the gas-admitting member and the extensible sleeve pipe jointly form a gas chamber, wherein the unidirectional gas piston is fitted inside the inner pipe and disposed downstream from a gas-admitting opening of the gas-admitting member to unidirectionally introduce external gas into the gas chamber.

In an embodiment of the present disclosure, the fluid pump further comprises a gauze gas-liquid mixing element disposed between the discharge channel and the first end of the first unidirectional valve.

Therefore, the fluid pump of the present disclosure not only delivers a fluid to the other end continually and unidirectionally but also outputs a fixed amount of the fluid with each press. Furthermore, a rebound element of the fluid pump is not in contact with the fluid, thereby minimizing the chance that the fluid will be contaminated.

### BRIEF DESCRIPTION OF THE DRAWINGS

FIG. 1 is a perspective view of a fluid pump according to the first embodiment of the present disclosure.

FIG. 2 is an exploded view of the fluid pump according to the first embodiment of the present disclosure.

FIG. 3A is a longitudinal cross-sectional view of the fluid pump according to the first embodiment of the present disclosure.

FIG. 3B is a schematic view of the squeezed fluid pump according to the first embodiment of the present disclosure.

FIG. 3C is a schematic view of the restored fluid pump according to the first embodiment of the present disclosure.

FIG. 4 is a perspective view of the fluid pump according to the second embodiment of the present disclosure.

FIG. 5 is an exploded view of the fluid pump according to the second embodiment of the present disclosure.

FIG. 6A is a transverse cross-sectional view of the fluid pump according to the second embodiment of the present disclosure.

FIG. 6B is a longitudinal cross-sectional view taken along line A-A of FIG. 6A.

FIG. 7A is a longitudinal cross-sectional view taken along line B-B of FIG. 6A.

FIG. 7B is a schematic view of the squeezed fluid pump according to the second embodiment of the present disclosure.

FIG. 7C is a schematic view of the restored fluid pump according to the second embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

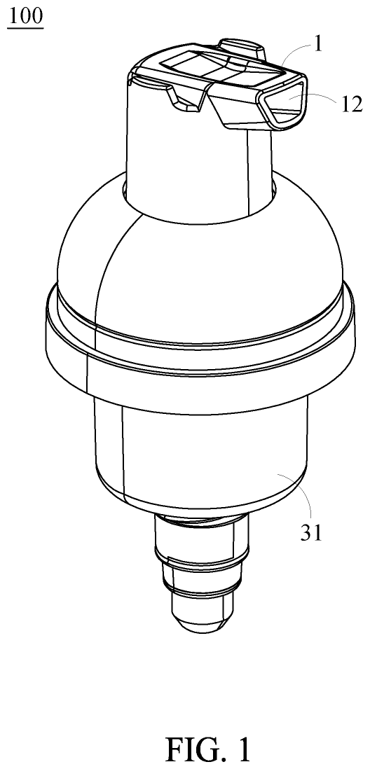

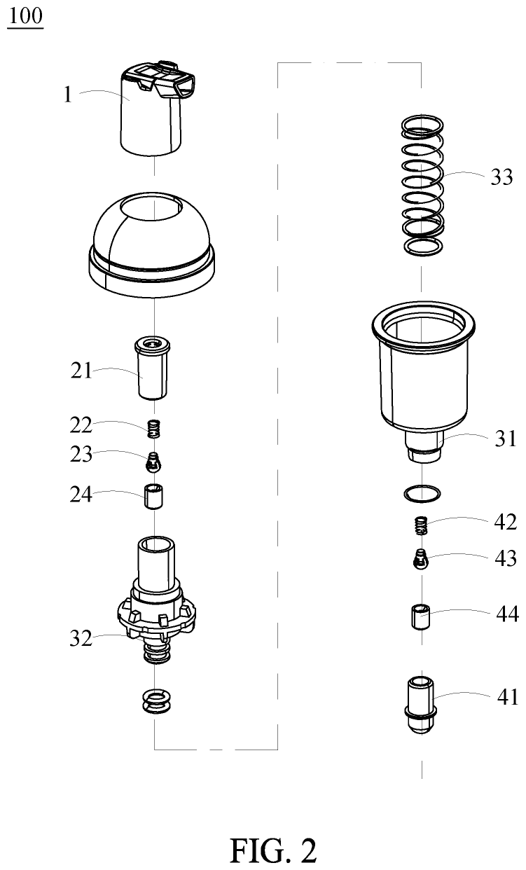

Referring to FIG. 1 through FIG. 3A, a fluid pump 100 in the first embodiment of the present disclosure comprises a press head portion 1, a first unidirectional valve 2, an extensible sleeve pipe 3, and a second unidirectional valve 4.

The press head portion 1 has a discharge channel 11 and a discharge vent 12.

The first unidirectional valve 2 is disposed in the press head portion 1. The first unidirectional valve 2 allows a fluid to flow from a second end 2b thereof to a first end 2a thereof but not from the first end 2a to the second end 2b. The first end 2a is in communication with the discharge channel 11. After passing the first unidirectional valve 2, the fluid goes to the discharge channel 11 before being discharged from the discharge vent 12. The first unidirectional valve 2 can be a conventional unidirectional valve.

The extensible sleeve pipe 3 comprises an outer pipe 31, an inner pipe 32 and a rebound element 33. The inner pipe 32 has a first end 32a being in communication with the first unidirectional valve 2 and a second end 32b fitted to a first end 31a of the outer pipe 31. The inner pipe 32 and outer pipe 31 jointly form a capacity-variable storage chamber L. The deeper the inner pipe 32 moves into the outer pipe 31, the lesser is the capacity of the storage chamber L. The rebound element 33 is connected to the outer pipe 31 and inner pipe 32. Resilience energy stored in the rebound element 33 enables the inner pipe 32 to rebound and restore its initial position.

The second unidirectional valve 4 allows the fluid to flow from a second end 4b thereof to a first end 4a thereof but not from the first end 4a to the second end 4b. The first end 4a is in communication with a second end 31b of the outer pipe 31. The second unidirectional valve 4 can be a conventional unidirectional valve.

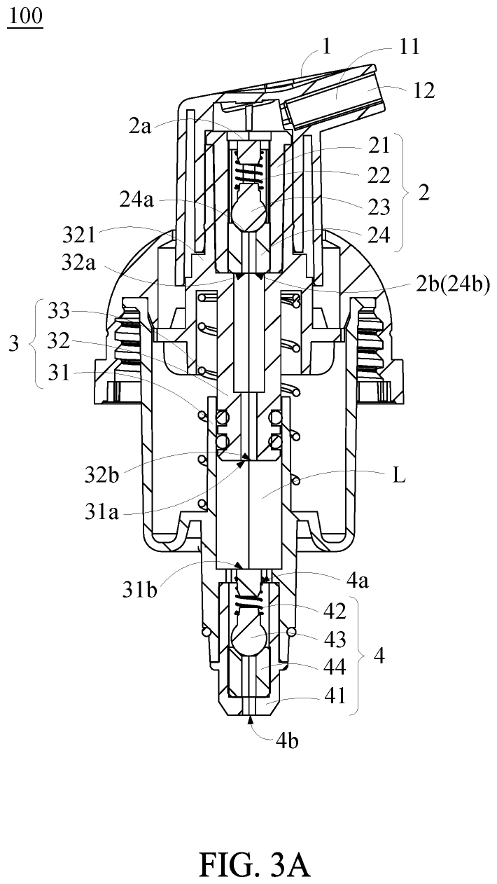

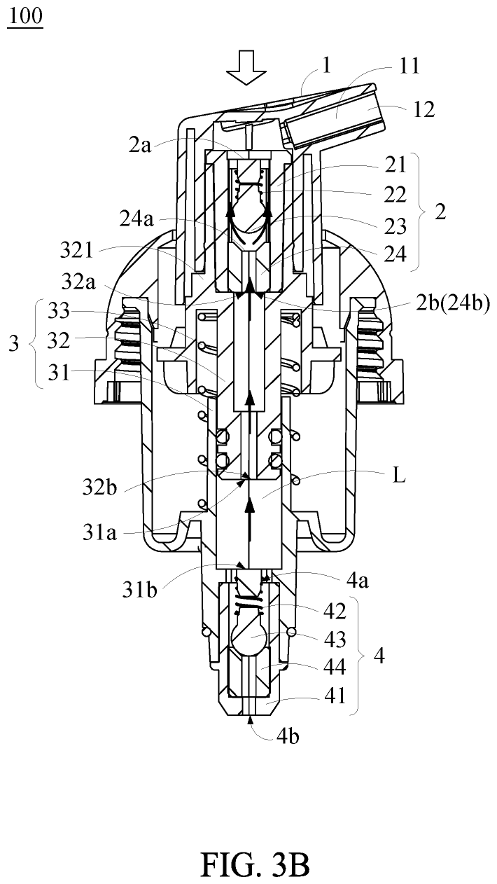

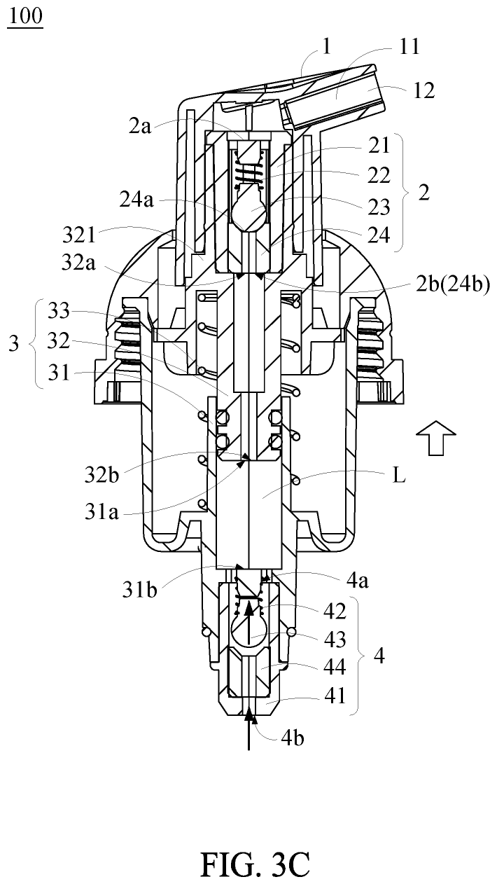

FIG. 3A through FIG. 3C depict how to press the fluid pump 100 and dispense a fixed amount of a fluid.

Referring to FIG. 3A, in the absence of any applied force, the storage chamber L is fully stored with liquid, and liquid pressure equilibrium exists between the storage chamber L, first unidirectional valve 2, and second unidirectional valve 4.

In this embodiment, the first unidirectional valve 2 comprises a first valve unit 21, a first resilient element 22, a first ball 23 and a first cork tube 24. The first resilient element 22, first ball 23 and first cork tube 24 are disposed in the first valve unit 21. A second end 24b of the first cork tube 24 is in communication with the first end 32a of the inner pipe 32. The first resilient element 22 presses the first ball 23, such that the first ball 23 normally abuts against a first end 24a of the first cork tube 24. Therefore, as long as the first resilient element 22 is pressing the first ball 23, the first unidirectional valve 2 blocks the communication of the storage chamber L and the discharge channel 11.

Referring to FIG. 3B, the press head portion 1 is pressed and moved downward to drive the first unidirectional valve 2 and the inner pipe 32 moving toward the outer pipe 31. The contraction displacement of the inner pipe 32 toward the outer pipe 31 causes a reduction in the capacity of the storage chamber L, thereby increasing the liquid pressure in the storage chamber L. As soon as the increasing liquid pressure overcomes pressure provided by the first resilient element 22, the fluid pushes the first ball 23 upward; consequently, the first unidirectional valve 2 is in communication with the storage chamber L and discharge channel 11. After that, the fluid passes through the first unidirectional valve 2 and then the discharge channel 11 before being discharged from the fluid pump 100 via the discharge vent 12.

The liquid pressure of the storage chamber L act in different directions simultaneously. Under the liquid pressure of the storage chamber L, the second unidirectional valve 4 prevents the fluid from going to the storage chamber L. The fluid in the storage chamber L is discharged, and thus the liquid pressure in the storage chamber L is reduced to such an extent as to be no longer greater than the pressure of the first resilient element 22, thereby allowing the first ball 23 to resume abutting against the first end 24a of the first cork tube 24.

In this embodiment, the second unidirectional valve 4 comprises a second valve unit 41, a second resilient element 42, a second ball 43 and a second cork tube 44. The second resilient element 42, second ball 43 and second cork tube 44 are disposed in the second valve unit 41. The second resilient element 42 presses the second ball 43, such that the second ball 43 is normally fitted inside the second cork tube 44 to stop the fluid from passing through the second unidirectional valve 4. When the liquid pressure of the storage chamber L increases, its pressure direction is the same as the direction in which the second resilient element 42 is pressing, thereby allowing the second ball 43 to abut against the second cork tube 44 harder. As a result, the fluid cannot pass through the second unidirectional valve 4 and go to the storage chamber L.

Therefore, each instance of pressing the fluid pump 100 always causes the fluid pump 100 to dispense a fixed amount of the fluid.

Referring to FIG. 3C, disappearance of the applied force is followed by release of the resilience energy previously stored in the rebound element 33 as a result of the press, such that the inner pipe 32 rebounds and restores its initial position. At this moment, the capacity of the storage chamber L increases because of expansion displacement. However, part of the fluid in the storage chamber L has already been discharged, and thus the liquid pressure of the storage chamber L is lower than the pressure of the outside. The difference in pressure between the outside and the storage chamber L causes the first ball 23 to abut against the first cork tube 24 harder. The pressure difference is greater than the pressure provided by the second resilient element 42, and thus the external fluid pushes the second ball 43 upward; consequently, the second unidirectional valve 4 is opened, such that the external fluid passes through the second unidirectional valve 4 and goes to the storage chamber L. When the pressure difference between the storage chamber L and the outside no longer overcomes the pressure provided by the second resilient element 42, the second ball 43 becomes fitted inside the second cork tube 44 and thus shuts the second unidirectional valve 4.

FIGS. 3A-3C show how to carry out one instance of the press cycle of the fluid pump 100.

The fluid pump 100 of the present disclosure is pressed by a user to not only deliver a fluid to the end continuously and unidirectionally but also output a fixed amount of the fluid with each press. Furthermore, the rebound element is not in contact with the fluid and thus minimizes the chance that the fluid will be contaminated. In addition, after the press head portion 1 has been pre-pressed, leakage is unlikely to happen to the fluid pump 100.

Referring to FIG. 3A, in this embodiment, the first end 32a of the inner pipe 32 extends outward to form a top portion 321 which one end of the rebound element 33 abuts against.

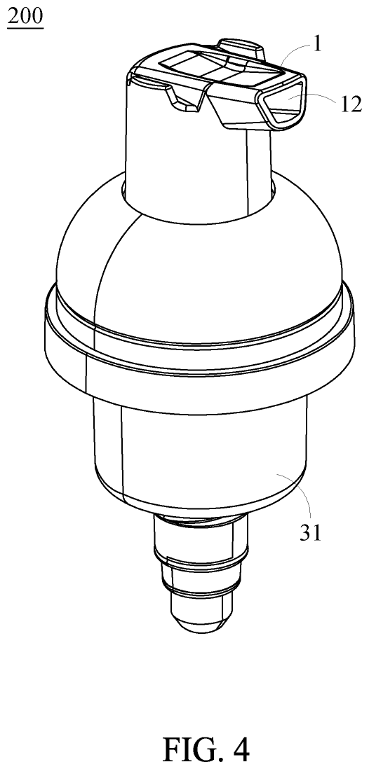

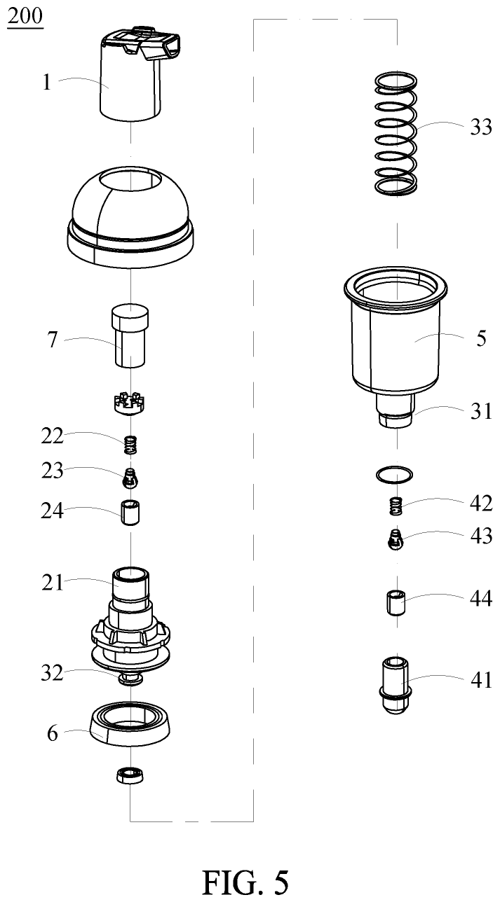

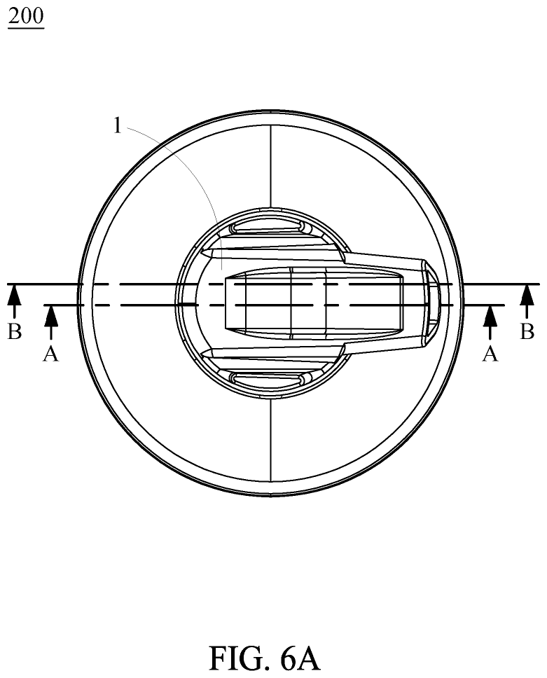

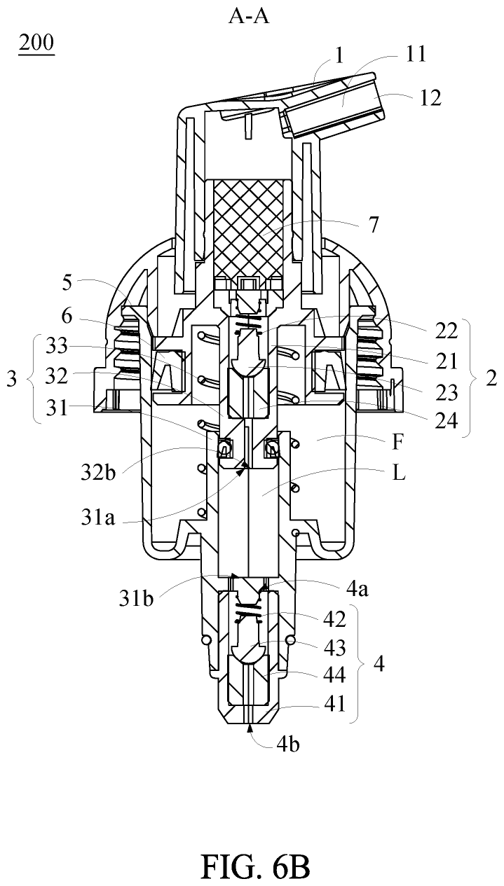

Referring to FIG. 4 through FIG. 7A, the present disclosure further provides the second embodiment. Referring to FIG. 5 through FIG. 6B, in the second embodiment, a fluid pump 200 further has a gas-admitting member 5, a unidirectional gas piston 6, and a gauze gas-liquid mixing element 7.

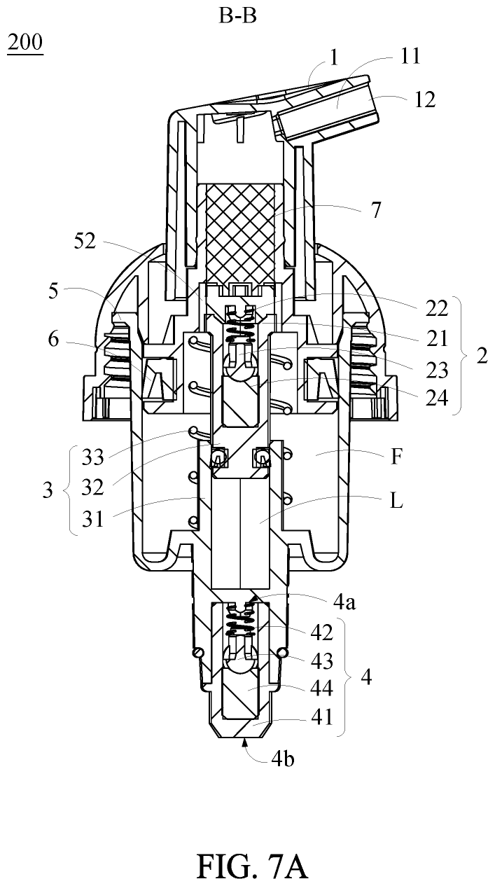

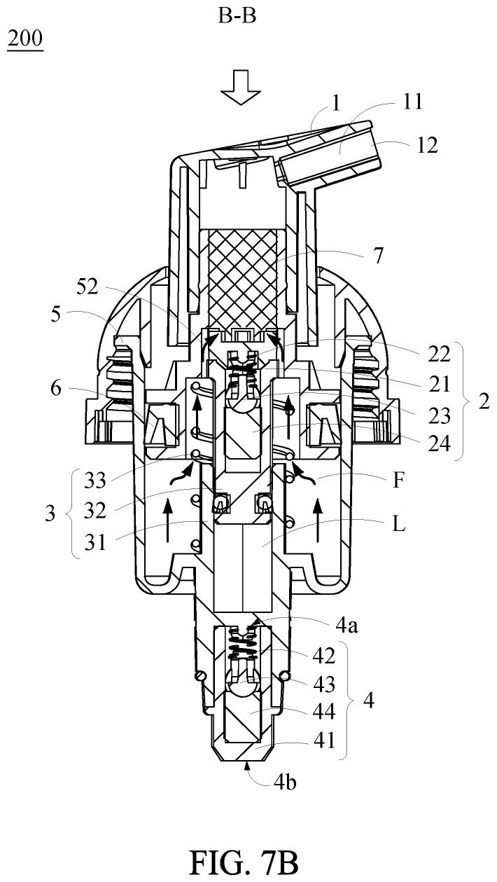

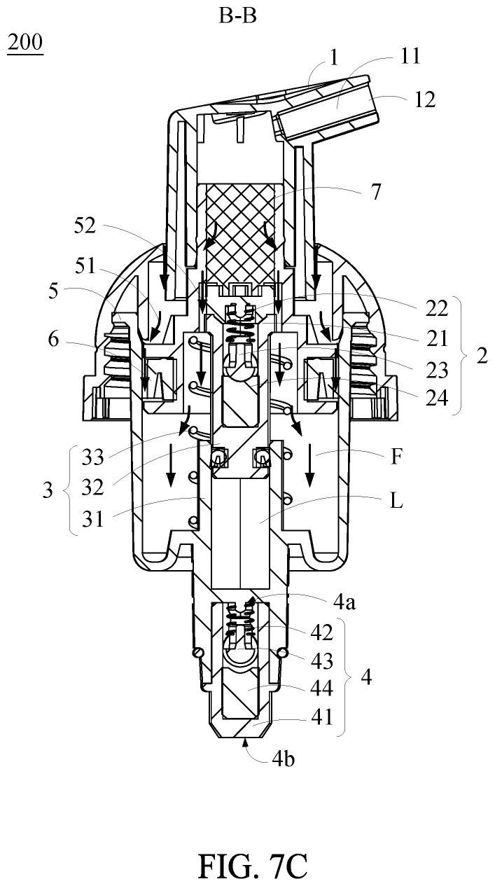

Referring to FIG. 7A, the gas-admitting member 5 surrounds the extensible sleeve pipe 3, such that the gas-admitting member 5 and the extensible sleeve pipe 3 jointly form a gas chamber F. Referring to FIG. 7B, the unidirectional gas piston 6 is fitted inside the inner pipe 32 and disposed downstream from a gas-admitting opening 51 (shown in FIG. 7C) of the gas-admitting member 5, such that external gas can flow unidirectionally into the gas chamber F. The gas-admitting member 5 further has a gas-releasing passage 52 which is in communication with the gas chamber F and the discharge channel 11. The gauze gas-liquid mixing element 7 is disposed between the discharge channel 11 and the first end 2a of the first unidirectional valve 2.

A fluid pump 200 in the second embodiment is pressed to dispense the fluid by the same principle and process as the fluid pump 100 in the first embodiment. The differences between the fluid pumps 100, 200 are described below. In the second embodiment, the fluid pump 200 is pressed to also dispense gas, such that the gas thus dispensed mixes with the fluid. The mixture of the gas and the fluid passes through the gauze gas-liquid mixing element 7 disposed in the discharge channel 11 to thereby become foamy. Therefore, the fluid pump 200 functions as a foam pump.

Referring to FIG. 7A, in the absence of any applied force, pressure equilibrium exists between the gas chamber F and the outside.

Referring to FIG. 7B, the press head portion 1 is pressed downward to drive the first unidirectional valve 2 and the inner pipe 32 moving toward the outer pipe 31. At this moment, the capacity of the gas chamber F decreases, and thus the pressure of the gas chamber F increases. The gas in the gas chamber F flows to the gauze gas-liquid mixing element 7 through the gas-releasing passage 52 and thus mixes with the fluid in the gauze gas-liquid mixing element 7 to produce foam. At last, the foam is delivered to the discharge channel 11 and discharged from the fluid pump 200 via the discharge vent 12.

Referring to FIG. 7C, disappearance of the applied force is followed by release of the resilience energy previously stored in the rebound element 33 as a result of the press, such that the inner pipe 32 rebounds and restores its initial position. At this moment, the capacity of the gas chamber F increases, and its pressure decreases. As soon as the pressure of the gas chamber F is lower than the pressure of the outside, the external gas squeezes the unidirectional gas piston 6, such that the unidirectional gas piston 6 contracts temporarily, thereby allowing the gas chamber F to communicate with the outside in order to supply supplementary gas. Furthermore, the gas propagates along the gas-releasing passage 52 and returns to the gas chamber F to also recycle any residual foam and thus prevent any lingering foam from ending up in the outside.

Referring to FIG. 7A, when pressure equilibrium between the gas chamber F and the outside is attained, the unidirectional gas piston 6 restores its initial position, such that the unidirectional gas piston 6 blocks the circulation of gas. Therefore, when pressed, the fluid pump 200 not only outputs a fluid but also outputs a gas, so as to mix the fluid and the gas; consequently, the mixture of the fluid and the gas becomes foamy.

While the present disclosure has been described by means of specific embodiments, numerous modifications and variations could be made thereto by those skilled in the art without departing from the scope and spirit of the present disclosure set forth in the claims.

What is claimed is:

1. A fluid pump, comprising:
a press head portion having a discharge channel and a discharge vent;
a first unidirectional valve disposed in the press head portion and adapted to allow a fluid to flow from a second end of the first unidirectional valve to a first end of the first unidirectional valve, wherein the first end of the first unidirectional valve is in communication with the discharge channel;
an extensible sleeve pipe comprising an outer pipe, an inner pipe and a rebound element, wherein the inner pipe has a first end being in communication with the first unidirectional valve and a second end fitted to the first end of the outer pipe, wherein the inner pipe and the outer pipe form a capacity-variable storage chamber and connect to the rebound element; and
a second unidirectional valve whereby a fluid flows from a second end thereof to a first end thereof, the first end being in communication with the second end of the outer pipe,
wherein, upon contraction displacement of the inner pipe, the storage chamber has a greater pressure than the first unidirectional valve, thereby allowing the fluid to exit the storage chamber and enter the discharge passage via the first unidirectional valve,
wherein, upon expansion displacement of the inner pipe, a pressure between the outside and the storage chamber is greater than a pressure of the second unidirectional valve, thereby allowing the fluid to flow into the storage chamber via the second unidirectional valve.

2. The fluid pump of claim 1, wherein the first unidirectional valve comprises a first valve unit, a first resilient element, a first ball and a first cork tube, wherein the first resilient element, the first ball and the first cork tube are disposed in the first valve unit, wherein a second end of the first cork tube is in communication with the first end of the inner pipe, wherein the first resilient element presses the first ball, such that the first ball normally abuts against the first end of the first cork tube.

3. The fluid pump of claim 1, wherein the second unidirectional valve comprises a second valve unit, a second resilient element, a second ball and a second cork tube, wherein the second resilient element, the second ball and the second cork tube are disposed in the second valve unit, wherein the second resilient element presses the second ball, such that the second ball is normally fitted inside the second cork tube.

4. The fluid pump of claim 1, wherein the first end of the inner pipe extends outward to form a top portion which an end of the rebound element abuts against.

5. The fluid pump of claim 1, further comprising a gas-admitting member and a unidirectional gas piston, the gas-admitting member having a gas-releasing passage in communication with the gas chamber and the discharge channel, wherein the gas-admitting member surrounds the extensible sleeve pipe, such that the gas-admitting member and the extensible sleeve pipe jointly form a gas chamber, wherein the unidirectional gas piston is fitted inside the inner pipe and disposed downstream from a gas-admitting opening of the gas-admitting member to unidirectionally introduce external gas into the gas chamber.

6. The fluid pump of claim 5, further comprising a gauze gas-liquid mixing element disposed between the discharge channel and the first end of the first unidirectional valve.
